(19) United States
(12) Patent Application Publication
(10) Pub. No.: US 2008/0290555 A1
(43) Pub. Date: Nov. 27, 2008

(54) Method for manufacturing rear set pan for vehicle using long glass fiber reinforced thermoplastic

(75) Inventors: Jong-Hyun Kim, Gyeonggi-do (KR); Sang-Nam Park, Chungcheongnam-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/983,140

(22) Filed: Nov. 6, 2007

(30) Foreign Application Priority Data
May 21, 2007 (KR) 10-2007-0049175

(51) Int. Cl. B29C 45/14

(52) U.S. Cl. 264/257

(57) ABSTRACT

The present invention provides a method for manufacturing a plastic rear seat pan for a vehicle by integrally injection molding long-glass-fiber reinforced thermoplastic polypropylene (PP-LFT), which is a high-strength plastic material, to achieve reduction in vehicle weight and production costs. The method includes providing a composite material comprising a polypropylene sheet reinforced with 30% long glass fiber; and integrally injection molding the composite material in a desired shape to obtain an integrally formed plastic rear seat pan.

### CROSS-REFERENCE TO RELATED APPLICATION

This application claims under 35 U.S.C. §119(a) on Korean Patent Application No. 10-2006-0049175, filed on May 21, 2007, the entire contents of which are incorporated herein by reference.

### BACKGROUND

(a) Technical Field

The present invention relates to a method for manufacturing a plastic rear seat pan for a vehicle. More particularly, the present invention relates to a method for manufacturing a plastic rear seat pan for a vehicle by integrally injection molding long-glass-fiber reinforced thermoplastic polypropylene (PP-LFT), which is a high-strength plastic material, to reduce vehicle weight and production costs.

(b) Background Art

Due to increasing needs for fuel efficiency, extensive research aimed at reducing vehicle weight has been made. To date, rear seat cushion frames for vehicles have been produced by a welding process with a steel material.

The reason for providing a relatively heavy seat weight is to satisfy users' demand for comfort and convenience and to actively cope with safety regulations that are getting more stringent every year. The increase in seat weight, however, is a serious obstacle in reducing vehicle weight and has put a strain on seat manufacturers and OEM manufacturers.

Accordingly, there is need for a seat cushion frame for a vehicle that can realize reduction in vehicle weight and production costs.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems, and an object of the present invention is to provide a method for manufacturing a plastic rear seat pan for a vehicle, which can reduce vehicle weight and production costs by a simple process.

In one aspect, the present invention provides a method for manufacturing a plastic rear seat pan for a vehicle including: providing a composite material comprising a polypropylene sheet reinforced with 30% long glass fiber; and injection molding the composite material in a desired shape to obtain an integrally formed plastic rear seat pan.

Preferably, the process of injection molding includes inserting woven long glass fiber reinforced thermoplastic at the front end of the plastic rear seat pan, which is a weak portion where stress is concentrated, to be injection molded.

Suitably, the process of injection molding includes: forming a plurality of ribs protruding upwardly at the front end of the plastic rear seat pan for providing anti-submarine function and providing between the ribs at least one reinforcing bead having a concave groove shape. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present methods will be particularly useful with a wide variety of motor vehicles.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present methods will be particularly useful with a wide variety of motor vehicles.

Other aspects of the invention are discussed infra.

### BRIEF DESCRIPTION OF THE DRAWINGS

FIG. 1 is schematic diagrams showing a plastic rear seat pan in accordance with the present invention and a conventional rear seat pan manufactured by a steal welding method;

FIG. 2A is a graph showing properties of PP-LFT materials;

FIG. 2B is a graph showing the results of a high strain rate tensile test on high-impact PP-LFT with respect to speed;

FIG. 3 is a graph showing the results of the a high strain rate tensile test of the high-impact PP-LFT used for forming the plastic rear seat pan in accordance with the present invention;

FIG. 4 illustrates the installation positions of a general rear seat pan and a power adjustable rear seat pan;

FIG. 5 illustrates an anti-submarine structure provided at the front end of the plastic rear seat pan in accordance with the present invention; and

FIG. 6 illustrates woven LFT insert-injected at the front end of the plastic rear seat pan in accordance with the present invention.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

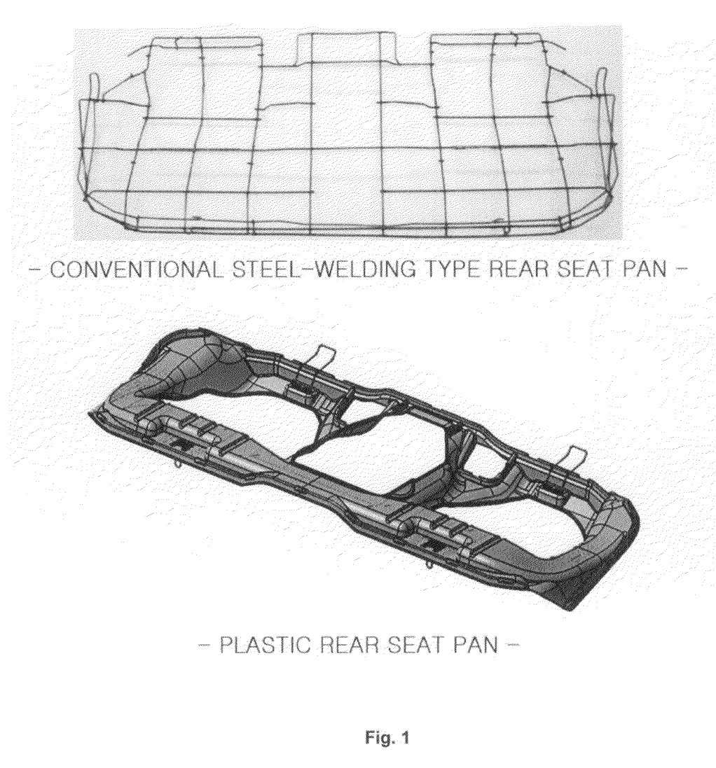

As shown in FIG. 1, an object of the present invention is to provide a method for manufacturing a plastic rear seat pan by integrally injection molding long-glass-fiber reinforced thermoplastic polypropylene (PP-LFT), compared with a conventional rear seat pan made of steel by a welding process.

As a material for forming the rear seat pan in accordance with the present invention, a composite material (PP-LFT) comprising a polypropylene sheet reinforced with 30% long glass fiber is used instead of a steel. While the density of steel is 7.80 g/cm³, the density of the high-strength plastic is 1.10 g/cm³.

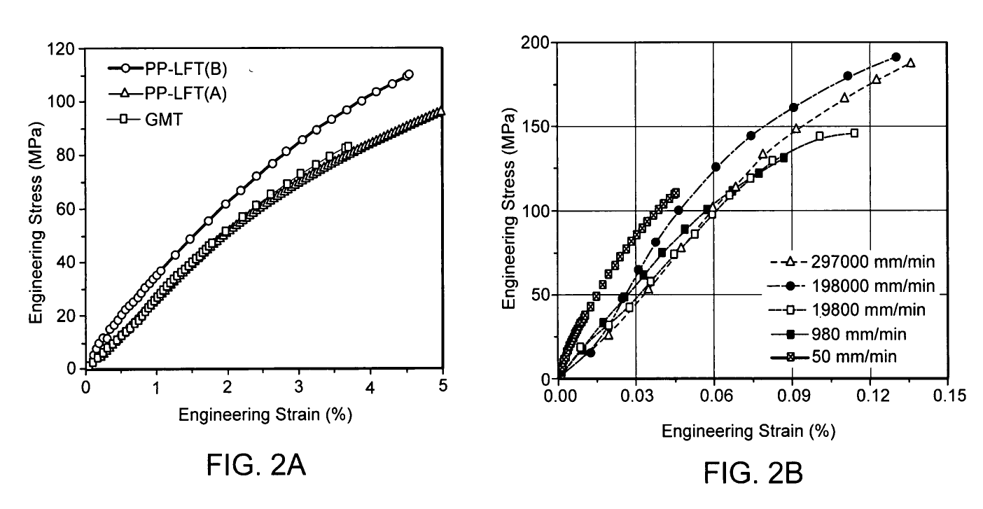

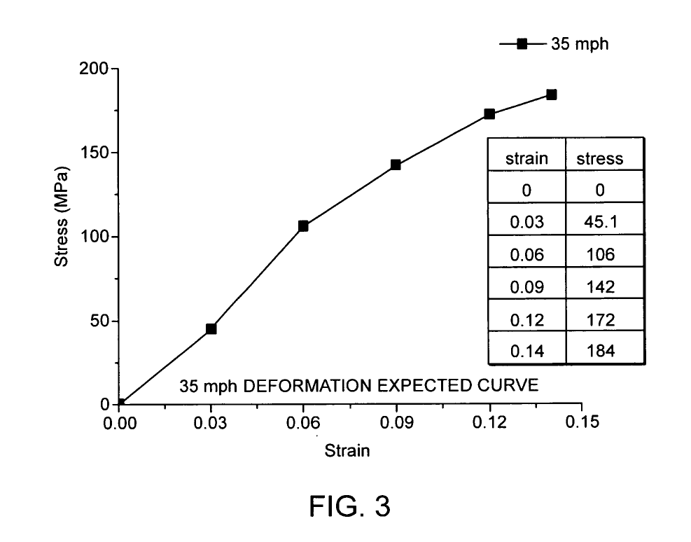

FIG. 2A is a graph showing properties of PP-LFT materials obtained at room temperature, in which A denotes general PP-LFT, B denotes high-impact PP-LFT, and C denotes glass mat thermoplastic (GMT), FIG. 2B is a graph showing the results of a high strain rate tensile test on high-impact PP-LFT with respect to speed, and FIG. 3 is a graph showing the results of the a high strain rate tensile test of the high-impact PP-LFT used for forming the plastic rear seat pan in accordance with the present invention.

The rear seat pan is required to be prevented from being damaged by a passenger's movement in a vehicle crash. To confirm whether the PP-LFT material meets this requirement, a high strain rate tensile test was carried out. From the test, an expected curve of 35 MPh (56 Km/h) was obtained. As shown in FIG. 3, it can be seen that the high-impact PP-LFT shows high tensile strength and elongation as deformation rate increases and has excellent properties in a vehicle crash.

Moreover, it can be ascertained, after a heat aging resistance test and a heat cycle test that are closely related to the long-term durability of the seat, that the high-impact PP-LFT maintains its properties more than 95% compared with the initial properties.

Accordingly, the plastic rear seat pan of the present invention can be formed of the high-impact PP-LFT having excellent properties such as tensile strength and elongation by an injection molding process.

That is, an integrally formed plastic rear seat pan can be obtained by injection molding the composite material comprising a polypropylene sheet reinforced with 30% long glass fiber in a desired shape.

Here, the structure of the plastic rear seat pan in accordance with the present invention will be described in more detail as follows.

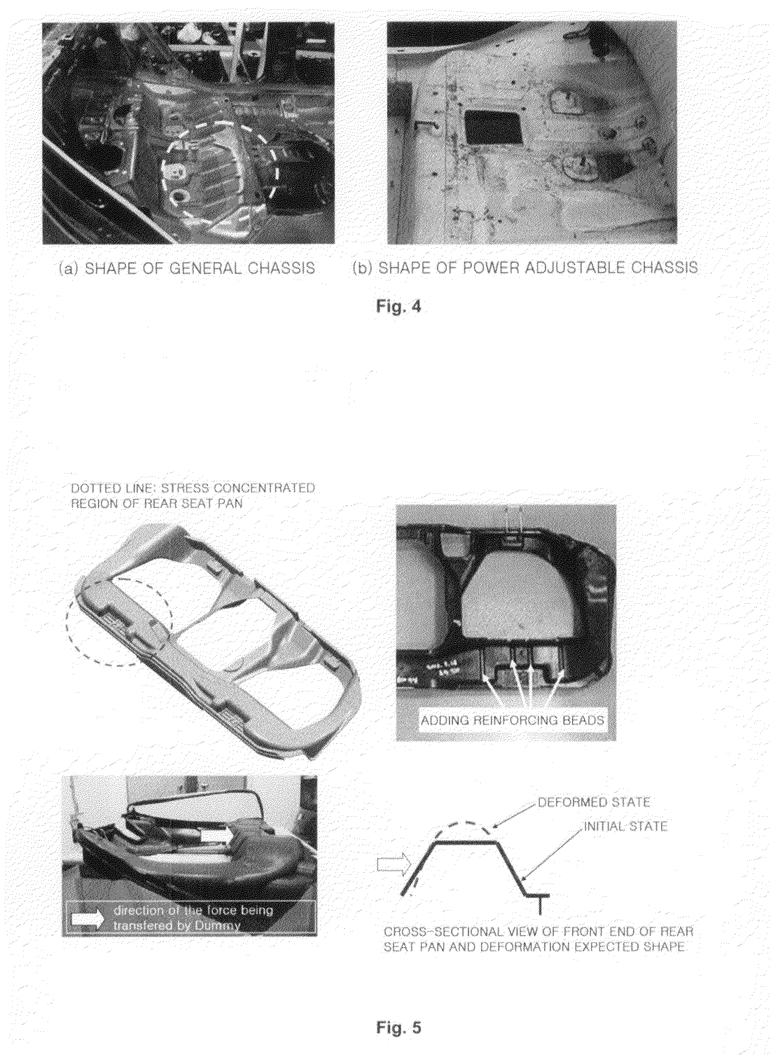

Most vehicles have an anti-submarine structure in the chassis thereof as shown in FIG. 4A. However, if the rear seat is a power adjustable seat (i.e., movable seat), it is required that the bottom of the chassis have a slow inclination.

Since the object of the present invention is to provide a seat pan suitable for the power adjustable rear seat, the plastic rear seat pan is designed to include the anti-submarine function as shown in FIG. 5.

That is, the present invention designs the anti-submarine structure for preventing the passenger from being thrown forward by inertia in a vehicle crash, not with a concept of a rigid body structure, but so as to receive a predetermined amount of deformation, thus inducing an impact absorbing effect. Moreover, the injection molding process of the present invention is performed by inserting reinforcing beads and employing a minimum number of rib structures so as to reduce the increase in part weight and to ensure an effective stress transfer.

In more detail, in injection molding process of the plastic rear seat pan, a plurality of ribs protruding upward is formed at the front end thereof to provide the anti-marine function and, at the same time, a reinforcing bead having a concave groove shape is provided between the respective ribs.

In a conventional plastic front seat pan, a panel thereof for performing the anti-submarine function is designed in the rigid body structure using PA6 resin.

More particularly, thick and deep ribs are inserted thereinto to prevent the plastic from being damaged and the PA 6 resin having excellent mechanical properties is used. However, the conventional plastic seat pan has problems in that the density of the PA6 resin material is higher about 60% than that of the PP resin used in the present invention, it requires a lot of ribs for reinforcing the structure, and the price of the PA6 resin material is higher about 60% than that of the PP resin, thus reducing the advantages of the reductions in weight and in production costs.

On the other hand, the rear seat pan manufactured by injection molding the composite material comprising a polypropylene sheet reinforced with 30% long glass fiber in a desired shape in accordance with the present invention further includes a structure for preventing parts from being damaged as stress is concentrated by excessive deformation of the plastic in a crash, besides the anti-submarine structure.

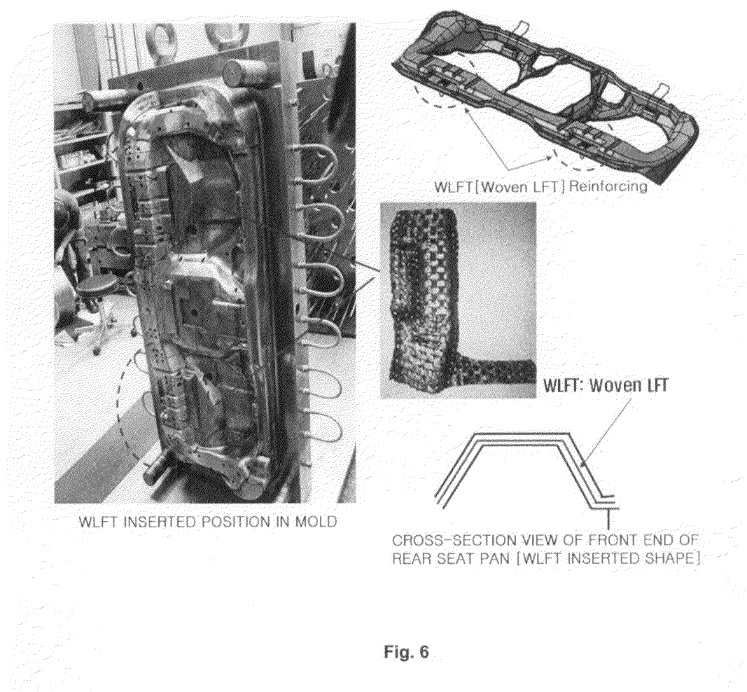

That is, as shown in FIG. 6, woven LFT is inserted at the front end of the plastic rear seat pan, which is a weak portion where stress is concentrated, and injection molded, thus minimizing the increase in weight and maximizing the strength.

As described above, according to the method for manufacturing a plastic rear seat pan for a vehicle by integrally injection molding a composite material comprising a polypropylene sheet reinforced with 30% long glass fiber, instead of a convention rear seat pan made of steel by a welding process, it is possible to provide the following effects: 1) achieving a reduction in weight (density of steel: 7.80 g/cm³/density of high-strength plastic: 1.10 g/cm³) using a plastic material which is a low-density material; 2) providing process simplification by replacing the welding process with the integral injection molding process; and 3) achieving an improvement in productivity and a reduction in production costs by avoiding welding defects caused by the welding process.

Moreover, the rear seat pan made of high-strength plastic in accordance with the present invention achieves a reduction in weight of about 34% compared with the conventional steel seat pan.

Furthermore, the present invention achieves a reduction in weight of various vehicles such as a passenger car, a sport utility vehicle (SUV), and the like, to which the conventional steel materials were applied in the past, and can be applied to second and third rows of bench type seats or split type seats.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a plastic rear seat pan comprising:
providing a composite material comprising a polypropylene sheet reinforced with 30% long glass fiber; and
injection molding the composite material in a desired shape to obtain an integrally formed plastic rear seat pan.

2. The method of claim 1, wherein the injection molding comprises inserting woven long glass fiber reinforced thermoplastic at the front end of the plastic rear seat pan, which is a weak portion where stress is concentrated.

3. The method of claim 1, wherein the injection molding comprises: forming a plurality of ribs upwardly protruding at the front end of the plastic rear seat pan for providing anti-submarine function and providing between the ribs at least one reinforcing bead having a concave groove shape.
